(19) United States
(12) Patent Application Publication
(10) Pub. No.: US 2016/0277455 A1
(43) Pub. Date: Sep. 22, 2016

(54) Online Meeting Initiation Based on Time and Device Location

(71) Applicants: Yasi Xi, Hefei City (CN); Mingfeng Yang, Hefei City (CN); Zhaoyi Jin, Hefei City (CN)

(72) Inventors: Yasi Xi, Hefei City (CN); Mingfeng Yang, Hefei City (CN); Zhaoyi Jin, Hefei City (CN)

(21) Appl. No.: 14/660,524

(22) Filed: Mar. 17, 2015

(51) Int. Cl. H04L 29/06; H04L 29/08

(52) U.S. Cl. CPC H04L 65/403; H04L 65/1069; H04L 67/18

(57) ABSTRACT

A system comprises an interface and a processor communicatively coupled to the interface. The interface is configure to receive a first request from a first device to initiate an online meeting, the first request comprising first location information associated with the first device. The interface is further configured to receive a second request from a second device to initiate an online meeting, the second request comprising second location information associated with the second device. The processor is configured to determine whether to initiate an online meeting comprising the first device and the second device based on the first location information, the second location information, first time information associated with the first request, and second time information associated with the second request.

### TECHNICAL FIELD

The present disclosure relates generally to online meetings, and more specifically to initiating online meetings based on location information and time information associated with online meeting initiation requests.

### BACKGROUND

Online meetings provide a platform for collaboration, document sharing, and/or video conferencing between participants and their computer systems. For example, a participant in an online meeting may be able to share a view of their computer screen with the other participants in the meeting, allowing for each of the other participants to view the user's activities in approximately real time. As another example, online meeting participants may be able to collaborate on a shared document. The initiation of online meetings may require a number of steps before the participants are able to take advantage of the online meeting capabilities.

### BRIEF DESCRIPTION OF THE DRAWINGS

For a more complete understanding of particular embodiments and their advantages, reference is now made to the following description, taken in conjunction with the accompanying drawings, in which:

FIG. 1 illustrates an example system including computer devices participating in an online meeting, in accordance with embodiments of the present disclosure;

FIG. 2 illustrates an example computer system, in accordance with embodiments of the present disclosure;

FIGS. 3A-3B illustrate example user interface screens associated with online meeting initiation, in accordance with embodiments of the present disclosure;

FIGS. 4A-4C illustrate a view of example online meeting initiation requests, in accordance with embodiments of the present disclosure; and

FIG. 5 illustrates an example method for performing online meeting initiation based on user device location information and initiation request time information, in accordance with embodiments of the present disclosure.

### DETAILED DESCRIPTION OF EXAMPLE EMBODIMENTS

### Overview

A system comprises an interface and a processor communicatively coupled to the interface. The interface is configure to receive a first request from a first device to initiate an online meeting, the first request comprising first location information associated with the first device. The interface is further configured to receive a second request from a second device to initiate an online meeting, the second request comprising second location information associated with the second device. The processor is configured to determine whether to initiate an online meeting comprising the first device and the second device based on the first location information, the second location information, first time information associated with the first request, and second time information associated with the second request.

Embodiments of the present disclosure may provide numerous technical advantages. For example, certain embodiments of the present disclosure may allow for the initiation of an online meeting using less steps than traditional methods of initiation online meetings. As another example, certain embodiments may allow for the addition of participants to online meetings using less steps than required by traditional methods of joining ongoing online meetings.

Other technical advantages of the present disclosure will be readily apparent to one skilled in the art from the following figures, descriptions, and claims. Moreover, while specific advantages have been enumerated above, various embodiments may include all, some, or none of the enumerated advantages.

### DETAILED DESCRIPTION

Current online meeting software may require a user to initiate an online meeting between users by first entering user information such that invitations to the online meeting may be sent to the users. For example, a meeting organizer may have to enter contact information for each of the prospective meeting participants in order to send an e-mail or other type of invitation to the prospective participants. After waiting to receive the invitation, the prospective participants must open the invitation to learn meeting details or access a hyperlink to join the meeting. Using the information in the invitation, the prospective participants may then log in and/or otherwise join the online meeting.

This process may be quite cumbersome, however, for users that wish to initiate an online meeting with others close by without prior planning. For example, meeting participants located in the same conference room may wish to initiate an online meeting with one another to share or collaborate on a single document. These users must have one of the participants enter the contact information for each of the other participants in order to invite the others to join the online meeting. The others must then wait to receive the invitation before they are able to join the online meeting. Actually joining the meeting may take one or more additional steps, such as logging into the online meeting software application or entering one or more details of the online meeting.

Accordingly, particular embodiments of the present disclosure allow for the initiation of an online meeting between nearby users using a single button press on their computing device to send requests to initiate an online meeting. Using location information associated with computing devices and a time window for when the requests occur, an online meeting between users in the same proximity may be initiated. For example, the users in the conference room would need only press a button on their respective computing devices at or around the same time to send a request to initiate an online meeting. The request would include information about the computing devices' location or relative proximity (e.g., using global positioning system (GPS) information). An online meeting module may use the location information in the requests along with the times at which the requests are sent or received in order to determine whether to initiate an online meeting between the users. More particularly, the online meeting module may determine whether the locations of the computing devices are within a particular distance threshold and determine whether the requests were received within a particular time window. If the requests are received within the particular time window and also originate from devices in the same proximity as one another, the online meeting module may initiate an online meeting with each of the users in the conference room as participants.

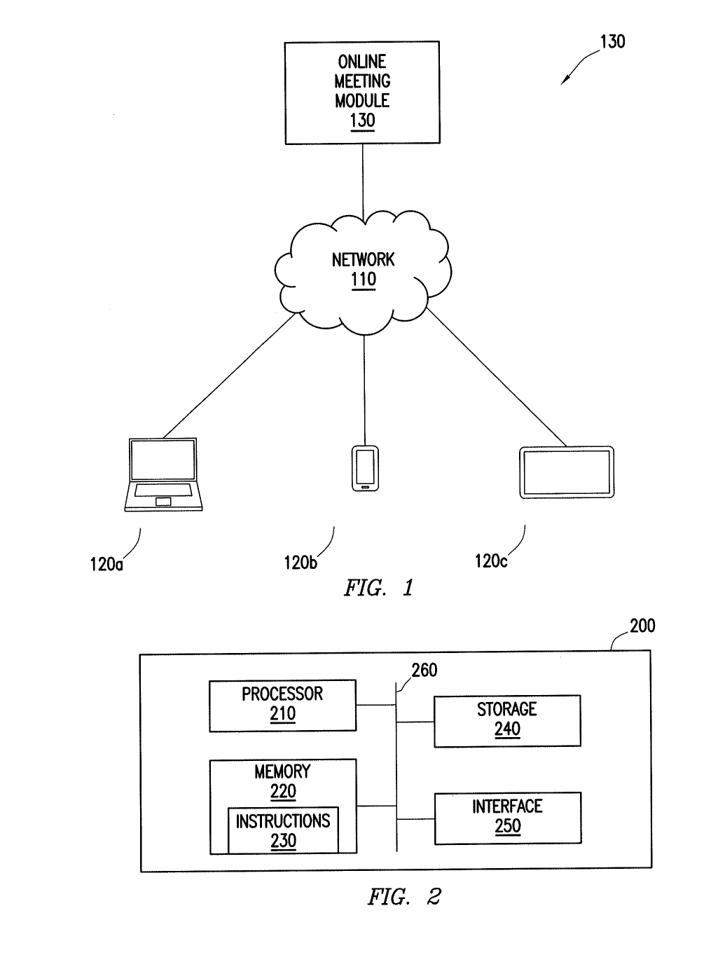

To facilitate a better understanding of the present disclosure, the following examples of certain embodiments are given. In no way should the following examples be read to limit, or define, the scope of the disclosure. Embodiments of the present disclosure and its advantages may be best understood by referring to FIGS. 1-5, where like numbers are used to indicate like and corresponding parts

FIG. 1 illustrates a system 100 that includes user devices 120 connected to network 110.

User devices 120 may include any suitable computing device that may be used to participate in an online meeting. In certain embodiments, user devices 120 may include mobile computing devices with wireless networking capabilities (e.g., wireless-fidelity (Wi-Fi), GPS, and/or BLUETOOTH capability). For example, user devices 120 may include laptop computers, smartphones, or tablet computers.

Network 110 may include any suitable technique for communicably coupling user devices 120. For example, network 110 may include an ad-hoc network, an intranet, an extranet, a virtual private network (VPN), a wired or wireless local area network (LAN), wide area network (WAN), metropolitan area network (MAN), a portion of the Internet, a portion of the Public Switched Telephone Network (PSTN), a portion of a cellular telephone network, or any combination thereof.

System 100 may further include an online meeting module 130 that may be operable to initiate and host online meetings between user devices 120. The functions of online meeting module 130 may be performed by any suitable combination of one or more servers or other components at one or more locations. In embodiments where the modules are servers, the servers may be public or private servers, and each server may be a virtual or physical server. The server may include one or more servers at the same or at remote locations. Online meeting module 130 may also include any suitable component that functions as a server. Online meeting module 130 may be any suitable software module for hosting and running online meeting applications (e.g., WEBEX). Online meeting module 130 may thus be operable to voice and/or video conferencing, document sharing, or other collaboration methods between user devices 120.

In particular embodiments, users of user devices 120 in close proximity to one another may wish to initiate an online meeting in order to, for example, share and collaborate on a single document using their respective user devices 120. Current online meeting systems may require the entry of each user's contact information in order to first send invitations, and may then require each of the users to open the invitations and use information therein to actually join or start the online meeting. However, as described more particularly below, aspects of the present disclosure may allow for users in close proximity to press a single button on their respective user devices 120 around the same time as one another in order to initiate an online meeting. For example, users in close proximity may press a button on their respective user devices 120 at or around the same time, which sends requests to an online meeting module indicating that they wish to initiate an online meeting. The online meeting module may then determine, based on location information and time information associated with each of the requests (e.g., by comparing the times at which the requests were received and/or comparing the relative locations of each user device 120), to initiate an online meeting comprising the user devices 120 associated with the users in close proximity.

Furthermore, in particular embodiments, additional users may be added to an ongoing online meeting using a similar one button press process. For example, when an online meeting is already underway, a user participating in the online meeting may press a button to allow other users to join. The additional users may press a button on their user device 120 at or around the same time as the user already participating in the online meeting to indicate they wish to join an ongoing online meeting. The online meeting module may then determine, based on location information and time information associated with each of these requests (e.g., by comparing the times at which the requests were received and/or comparing the relative locations of each user device 120), to allow the additional user to join the ongoing online meeting.

A component of system 100 may include an interface, logic, memory, and other suitable elements. An interface receives input, sends output processes the input and/or output, and performs other suitable operations. An interface may comprise hardware and software. Logic performs the operation of the component. For example, logic executes instructions to generate output from input. Logic may include hardware, software, and other logic. Logic may be encoded in one or more non-transitory, tangible media, such as a computer readable medium or any other suitable tangible medium, and may perform operations when executed by a computer. Certain logic, such as a processor, may manage the operation of a component. Examples of a processor include one or more computers, one or more microprocessors, one or more applications, and other logic.

Modifications, additions, or omissions may be made to FIG. 1 without departing from the scope of the present disclosure. For example, FIG. 1 illustrates particular types of user devices 120. However, as described above, any suitable computing devices may be used as user devices 120.

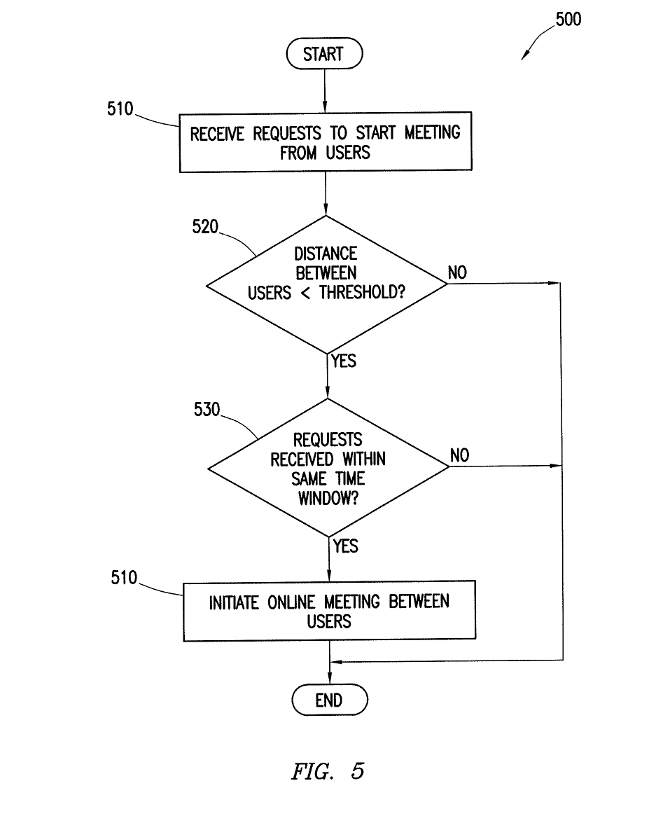

FIG. 2 illustrates an example computer system 200, in accordance with embodiments of the present disclosure. One or more aspects of computer system 200 may be used in user devices 120 and/or in online meeting module 130 of FIG. 1. Computer system 200 may include a processor 210, memory 220 comprising instructions 230, storage 240, interface 250, and bus 260. These components may work together to perform one or more steps of one or more methods (e.g. method 500 of FIG. 5) and provide the functionality described herein. For example, in particular embodiments, instructions 230 in memory 220 may be executed on processor 210 in order to initiate an online meeting between user devices 120 based on requests received from user devices 120 through interface 250. In certain embodiments, instructions 230 may reside in storage 240 instead of, or in addition to, memory 220.

Processor 210 may be a microprocessor, controller, application specific integrated circuit (ASIC), or any other suitable device or logic operable to provide, either alone or in conjunction with other components (e.g., memory 220 and instructions 230) online meeting initiation functionality. Such functionality may include initiating online meetings based on location information and time information, as discussed herein. In particular embodiments, processor 210 may include hardware for executing instructions 230, such as those making up a computer program or application. As an example and not by way of limitation, to execute instructions 230, processor 210 may retrieve (or fetch) instructions 230 from an internal register, an internal cache, memory 220, or storage 240; decode and execute them; and then write one or more results of the execution to an internal register, an internal cache, memory 220, or storage 240.

Memory 220 may be any form of volatile or non-volatile memory including, without limitation, magnetic media, optical media, random access memory (RAM), read-only memory (ROM), flash memory, removable media, or any other suitable local or remote memory component or components. Memory 220 may store any suitable data or information utilized by online meeting module 130, including software (e.g., instructions 230) embedded in a computer readable medium, and/or encoded logic incorporated in hardware or otherwise stored (e.g., firmware). In particular embodiments, memory 220 may include main memory for storing instructions 230 for processor 210 to execute or data for processor 210 to operate on. In particular embodiments, one or more memory management units (MMUs) may reside between processor 210 and memory 220 and facilitate accesses to memory 220 requested by processor 210.

Storage 240 may include mass storage for data or instructions (e.g., instructions 230). As an example and not by way of limitation, storage 240 may include a hard disk drive (HDD), a floppy disk drive, flash memory, an optical disc, a magneto-optical disc, magnetic tape, a Universal Serial Bus (USB) drive, a combination of two or more of these, or any suitable computer readable medium. Storage 240 may include removable or non-removable (or fixed) media, where appropriate. Storage 240 may be internal or external to online meeting module 130 (and/or remote transceiver 220), where appropriate. In some embodiments, instructions 230 may be encoded in storage 240 in addition to, in lieu of, memory 220.

Interface 250 may include hardware, encoded software, or both providing one or more interfaces for communication (such as, for example, packet-based communication) between computer systems on network 110 (e.g., between user devices 120 and/or online meeting module 130). As an example, and not by way of limitation, interface 250 may include a network interface controller (NIC) or network adapter for communicating with an Ethernet or other wire-based network and/or a wireless NIC (WNIC) or wireless adapter for communicating with a wireless network. Interface 250 may include one or more connectors for communicating traffic (e.g., IP packets) via a bridge card. Depending on the embodiment, interface 250 may be any type of interface suitable for any type of network in which online meeting module 130 is used. In some embodiments, interface 250 may include one or more interfaces for one or more I/O devices. One or more of these I/O devices may enable communication between a person and online meeting module 130. As an example, and not by way of limitation, an I/O device may include a keyboard, keypad, microphone, monitor, mouse, printer, scanner, speaker, still camera, stylus, tablet, touchscreen, trackball, video camera, another suitable I/O device or a combination of two or more of these.

Bus 260 may include any combination of hardware, software embedded in a computer readable medium, and/or encoded logic incorporated in hardware or otherwise stored (e.g., firmware) to communicably couple components of computer system 200 to each other. As an example and not by way of limitation, bus 260 may include an Accelerated Graphics Port (AGP) or other graphics bus, an Enhanced Industry Standard Architecture (EISA) bus, a front-side bus (FSB), a HYPERTRANSPORT (HT) interconnect, an Industry Standard Architecture (ISA) bus, an INFINIBAND interconnect, a low-pin-count (LPC) bus, a memory bus, a Micro Channel Architecture (MCA) bus, a Peripheral Component Interconnect (PCI) bus, a PCI-Express (PCI-X) bus, a serial advanced technology attachment (SATA) bus, a Video Electronics Standards Association local (VLB) bus, or any other suitable bus or a combination of two or more of these. Bus 260 may include any number, type, and/or configuration of buses 260, where appropriate. In particular embodiments, one or more buses 260 (which may each include an address bus and a data bus) may couple processor 210 to memory 220. Bus 260 may include one or more memory buses.

Modifications, additions, or omissions may be made to FIG. 2 without departing from the scope of the present disclosure. For example, FIG. 2 illustrates components of computer system 200 in a particular configuration. However, any configuration of processor 210, memory 220, instructions 230, storage 240, interface 250, and bus 260 may be used, including the use of multiple processors 210 and/or buses 260. In addition, computer system 200 may be physical or virtual.

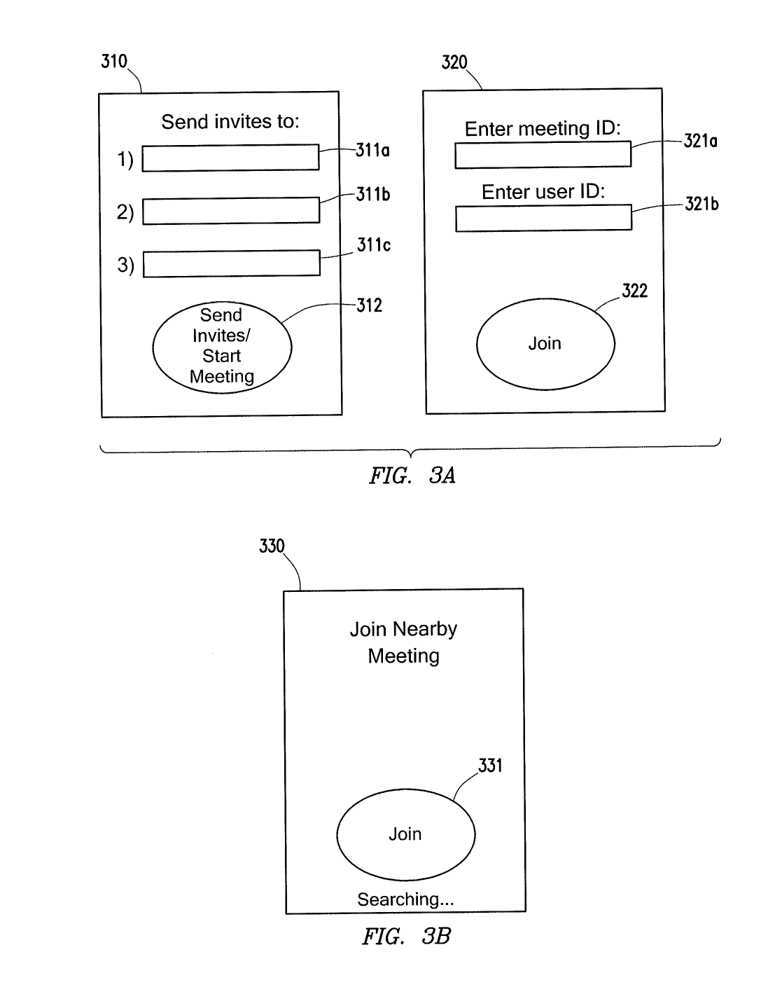

FIGS. 3A-3B illustrate example user interface screens 310-330 associated with online meeting initiation, in accordance with embodiments of the present disclosure. In particular, FIG. 3A illustrates an example user interface 310 of current online meeting software through which a user initiating an online meeting may enter contact information for prospective participants such that invitations to the online meeting may be sent to the prospective participants. For instance, a user of interface 310 may enter e-mail addresses, telephone numbers, or any other suitable contact information into fields 311. Once the information has been entered, the user may send the invitations and/or start the online meeting using button 312. FIG. 3A further illustrates an example user interface 320 of current online meeting software through which prospective participants of an online meeting may enter meeting details learned from the meeting invitation sent via interface 310. For instance, users of interface may enter a meeting identification number and/or user identification information into fields 321. Once such information has been entered, the user may then press button 322 to join the online meeting started by the user of interface 310.

As will be recognized by those of ordinary skill in the art, this process may be quite cumbersome for users that wish to quickly initiate an online meeting with others in close proximity. Thus, particular embodiments of the present disclosure may allow for the initiation of an online meeting between users using a single click or button press. An example interface 330 in accordance with embodiments of the present disclosure is illustrated in FIG. 3B. Using interface 330, users in close proximity (e.g., in the same conference room) may simply press button 331 on their respective user devices 120 at approximately the same time to send requests to an online meeting module (e.g., online meeting module 130 of FIG. 1) to initiate an online meeting. The requests sent by each user device 120 may include location information associated with user device 120, such as GPS information (e.g., coordinates), wireless network information (e.g., wireless access point identifier, wireless network service set identification (SSID), or network address such as an IP address), or any other suitable information for determining a location of user device 120 with respect to other devices. Online meeting module 130 may compare the location information in the requests to determine whether user devices 120 are within a particular distance of one another. In certain embodiments, the particular distance may be pre-determined. In some embodiments, the request may also include time information associated with when the request was sent by user device 120. In other embodiments, time information associated with each request may be determined by online meeting module 130 based on a time at which the request was received by online meeting module 130. Online meeting module 130 may compare the time information associated with each of the requests and use particular time windows to determine whether the requests were sent at approximately the same time. In certain embodiments, the particular time windows used may be pre-determined. If online meeting module 130 determines that the requests were sent from user devices 120 within the particular distance of one another and that the requests were also sent/received within the particular time window, then online meeting module 130 may initiate an online meeting comprising the users of user devices 120 that sent the requests.

Modifications, additions, or omissions may be made to FIGS. 3A-3B without departing from the scope of the present disclosure. For example, the interfaces of FIGS. 3A-3B are illustrated in a particular configuration. However, any suitable interface configuration for initiating online meetings according to the above descriptions may be used.

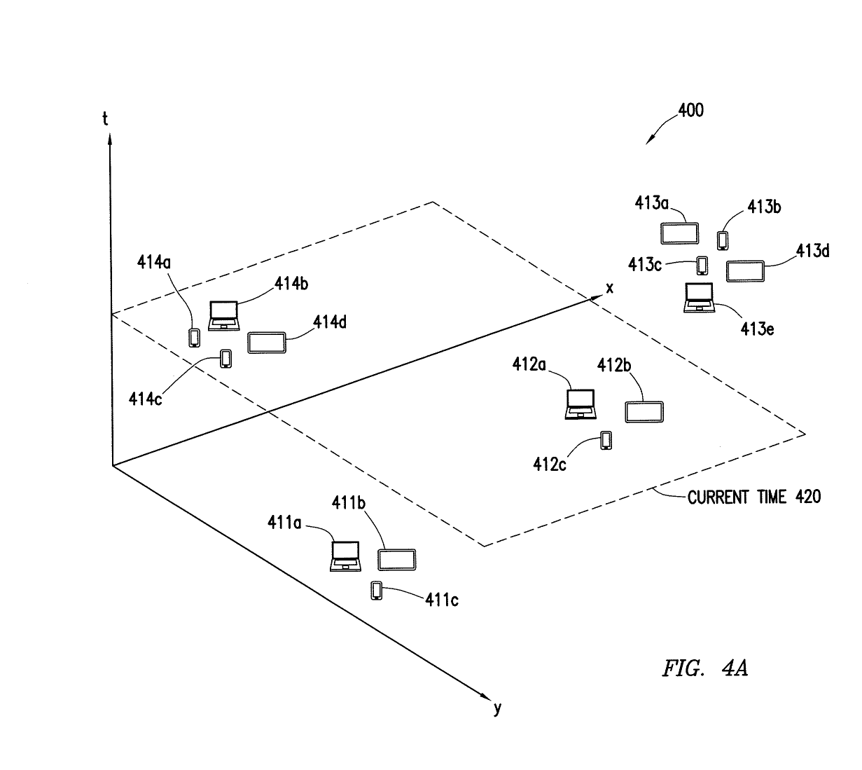

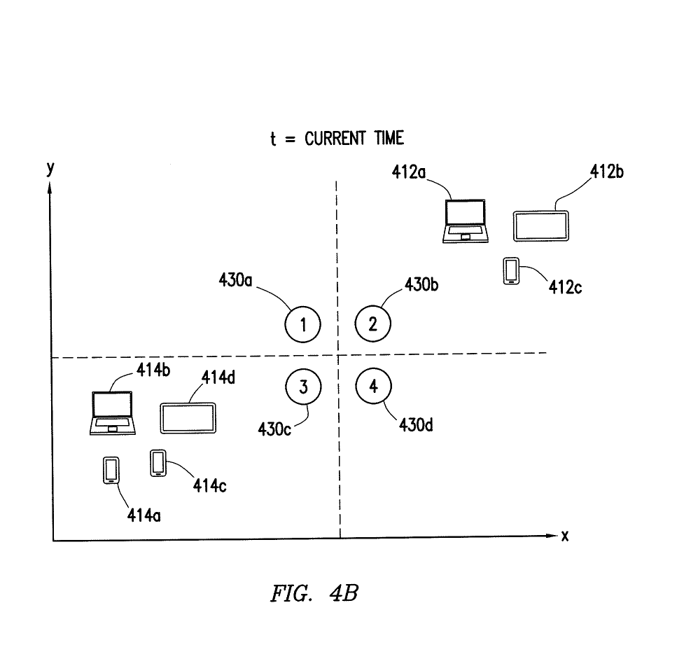

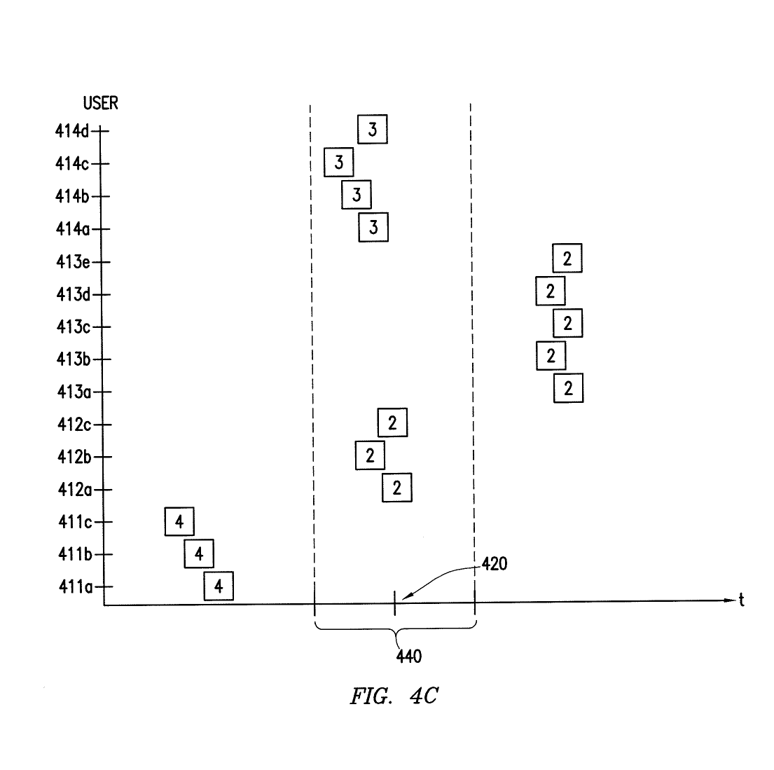

FIGS. 4A-4C illustrate a view 400 of example online meeting initiation requests, in accordance with embodiments of the present disclosure. In particular, FIG. 4A illustrates a three-dimensional view 400 of requests 411a-c, 412a-c, 413a-e, and 414a-d received from different users in different locations that wish to initiate online meetings with one another, as explained further below. The three dimensions of view 400 comprise x- and y-axes representing physical space, and a t-axis representing time. Although illustrated as three dimensions, it will be understood that aspects of the present disclosure may utilize additional dimensions, such as height (z-direction) or network information, to determine online meeting initiation parameters.

View 400 depicts sets of requests 411-414 being sent at different times and locations. The sets of requests each represent requests from users near each other that wish to initiate online meetings with one another. That is, requests 411 come from a first set of users near each other that wish to initiate a first online meeting, requests 412 come from a second set of users near each other that wish to initiate a second online meeting, requests 413 come from a third set of users near each other that wish to initiate a third online meeting, and requests 414 come from a fourth set of users near each other that wish to initiate a fourth online meeting. It will be understood that view 400 depicts requests 411 as occurring before all other requests in view 400 and that requests 411 originate from devices near a first location. Likewise, requests 412 and 414 occur at approximately the same time as each other after requests 411 and before requests 413, but originate from devices near second and third locations, respectively. Finally, requests 413 occur after each of the other sets of requests 411, 412, and 414, but near the same second location as where requests 412 originated from.

Each of requests 411-414 may comprise location information in particular embodiments. The location information may be any suitable information regarding the location of user device 120. In some embodiments, the location information may be determined based on wireless data signals associated with user device 120. For example, the location information may include GPS information, network information (e.g., IP address, wireless SSID, VPN information), or information gathered from BLUETOOTH radio signals of user device 120 (e.g., which user devices 120 are within range of the BLUETOOTH radio of the device).

In certain embodiments, each of requests 411-414 may also comprise time information. The time information may be any suitable information associated with when user device 120 has requested to initiate the online meeting. For example, the time information may include a time at which user device 120 sends the request to online meeting module 130 (e.g., a timestamp placed in the request by user device 120 just prior to sending). In other embodiments, the time information may be associated with the request by a module communicably coupled to user devices 120 through a network, such as online meeting module 130 to which the device is sending the request. For example, online meeting module 130 may associate time information with each request as it is received (e.g., using a timestamp).

Based on the time information and the location info, nation, online meeting module 130 may determine whether to initiate online meetings between user devices 120. FIGS. 4B-4C illustrate example methods of making such determinations. For instance, FIG. 4B illustrates a spatial view of the requests of view 400 at a current time 420 (illustrated as a plane in view 400 FIG. 4A). The requests received at a particular time may come from different locations, as shown. The location information may be determined in any suitable way. As one example, a covered space may comprise spatial divisions such as spaces 430 illustrated in FIG. 4B. In such an example, the location information may comprise information regarding the space 430 from which the request originates. This may be determined using GPS information, wireless SSID information, nearby device information derived from BLUETOOTH signals, or any other information which may allow online meeting module 130 to determine a relative spatial location of user device 120. Time information for each of the requests may also be compared. For instance, FIG. 4C illustrates a time-elapsed view of the requests illustrated in view 400 of FIG. 4A, including the respective location information for each request. In particular, the location information associated with requests 414 may include the number 3 representing the space 430 from which they originated, while the location information associated with requests 412 may include the number 2 representing the space 430 from which they originated.

Using the location information (e.g., an indication of a space 430 from which the request originated) and the time information (e.g., a timestamp of when the request was sent from the device) associated with each of the requests, online meeting module 130 may determine to initiate meetings for devices that requested initiation around the same time and near the same location. For example, online meeting module 130 may apply a time window around a particular time to determine which requests were sent or received at approximately the same time. Referring to FIG. 4C, requests 412 and 414 may be determined to be sent or received at approximately the same time as they are within time window 440 around time 420. Online meeting module 130 may compare location information for each of the requests within the particular time window to determine whether they were intended to join the same online meeting. Referring again to FIG. 4C, requests 412 may be determined to be requesting a separate online meeting than requests 414 based on the differing location information in the respective requests. Accordingly, online meeting module 130 would initiate two online meetings: one comprising the devices that sent requests 412, and another comprising the devices that sent requests 414.

It will be recognized by those of ordinary skill in the art that online meeting module 130 may initiate separate online meetings for requests 411 and 413, since those requests have the same or similar location information (i.e., requests have “4” as their location information and requests 413 have “2” as their location information) and may occur within other time windows not explicitly illustrated in FIG. 4C. It will also be recognized that, although requests 412 and 413 include the same location information (i.e., “2”), online meeting module 130 may not initiate an online meeting comprising the user devices 120 sending requests 412 and 413 since the requests occurred during different time windows.

Modifications, additions, or omissions may be made to FIGS. 4A-4C without departing from the scope of the present disclosure. For example, view 400 of FIGS. 4A-4C comprises a particular set of requests 411-414 occurring at particular times and originating from particular locations. However, any suitable sequence of requests originating from any suitable number of locations may be received by an online meeting module and analyzed according to the methods described in the present disclosure.

FIG. 5 illustrates an example method 500 for performing online meeting initiation based on user device location information and initiation request time information, in accordance with embodiments of the present disclosure. Method 500 may be performed using one or more computer systems, such as computer system 200 of FIG. 2, located in one or more components of a network, such as network 110 of FIG. 1. For example, method 500 may be performed by one or more computer systems located in an online meeting module, such as online meeting module 130 of FIG. 1.

Method 500 may begin at step 510, where requests to initiate online meetings are received from a plurality of users of user devices on a network. The requests may include a first request from a first user device and a second requests from a second user device. The first request may comprise first location information associated with the first user device, while the second request may comprise second location information associated with the second user device. The location information may include any suitable information for determining a location of a user device from which the location information was sent. The location information may be based on wireless data signals associated with the user device, in particular embodiments. For example, the location information may include information from a GPS antenna coupled to the user device. As another example, the location information may include wireless network information such as a wireless network SSID or a network address. As yet another example, the location information may include information about nearby user devices determined from BLUETOOTH data signals coming from the nearby user devices.

At step 520, it is determined whether a distance between the users is less than a particular threshold. The threshold may be pre-determined, and the distance between user devices may be determined using the location information from the requests. Referring to the above situation involving the first request and the second request, the first location information may be compared to the second location information in order to determine a relative distance between the two user devices. The relative distance between the user devices may then be compared to a pre-determined threshold. As an example, using received GPS information from a number of user devices, distances between the user devices may be determined and compared to a threshold such as 50 feet or 100 feet.

At step 530, it is determined whether the requests were received within a particular time window. The time information may be based, in certain embodiments, on a time at which the request was sent by a user device. In other embodiments, the time information may be based on a time at which the request was received by online meeting module. Referring again to the above situation involving the first requests and second request, this may include determining whether the first request was received within a pre-determined amount of time from the second request. For example, the time information associated with the first request may be compared to the time information associated with the second request to determine a time difference, and then the time difference may be compared to a threshold such as 1 second or 3 seconds.

If the user devices are determined to be in close proximity at step 520 (e.g., within the pre-determined distance threshold) and the requests have been received within a particular time window (e.g., the time difference between requests is within a pre-determined time threshold), the method proceeds to step 540 where an online meeting is initiated comprising user devices.

In certain embodiments, these aspects may be used to also allow additional users to join an ongoing online meeting. That is, a user participating in an ongoing online meeting may press a button on their user device at or near the same time as an additional user in the same vicinity who wishes to join the meeting. For instance, referring to the above situation, the online meeting module may receive a third request from the first user device comprising third location information associated with the first user device and a fourth request from a third user device comprising fourth location information associated with the third user device. The online meeting module may then determine whether to allow the third user to join the online meeting based on the third location information, the fourth location information, third time information associated with the third request, and fourth time information associated with the fourth request. This may include determining, using the third location information and the fourth location information, whether the first user device is located within a pre-determined distance from the third user device and determining, using the third time information and the fourth time information, whether the third request was received within a pre-determined amount of time from the fourth request. It will be understood by those of ordinary skill in the art that these steps may allow for users to leave the location at which they initiated an ongoing online meeting and allow another user at a different location to join the ongoing online meeting using the same one button press process.

Modifications, additions, or omissions may be made to method 500 without departing from the scope of the present disclosure. For example, the order of the steps may be performed in a different manner than that described and some steps may be performed at the same time. Additionally, each individual step may include additional steps without departing from the scope of the present disclosure.

Although various implementations and features are discussed with respect to multiple embodiments, it should be understood that such implementations and features may be combined in various embodiments. For example, features and functionality discussed with respect to a particular figure, such as FIG. 2, may be used in connection with features and functionality discussed with respect to another such figure, such as FIGS. 3-5, according to operational needs or desires.

Numerous other changes, substitutions, variations, alterations and modifications may be ascertained by those skilled in the art and it is intended that particular embodiments encompass all such changes, substitutions, variations, alterations and modifications as falling within the spirit and scope of the appended claims.

What is claimed is:

1. A system, comprising:
an interface configured to:
receive a first request from a first device to initiate an online meeting, the first request comprising first location information associated with the first device; and
receive a second request from a second device to initiate an online meeting, the second request comprising second location information associated with the second device; and
a processor communicatively coupled to the interface, the processor configured to:
determine whether to initiate an online meeting comprising the first device and the second device based on the first location information, the second location information, first time information associated with the first request, and second time information associated with the second request.

2. The system of claim 1, wherein the processor configured to determine whether to initiate the online meeting is further configured to determine, using the first location information and the second location information, whether the first device is located within a pre-determined distance from the second device.

3. The system of claim 1, wherein the processor configured to determine whether to initiate the online meeting is further configured to determine, using the first time information and the second time information, whether the first request was received within a pre-determined amount of time from the second request.

4. The system of claim 1, wherein the first location information is determined based on wireless data signals associated with the first device.

5. The system of claim 1, wherein the first time information is determined based on a time at which the first request was received.

6. The system of claim 1, wherein:
the interface is further configured to:
receive a third request from the first device to allow another device to join the online meeting, the third request comprising third location information associated with the first device;
receive a fourth request from a third device to join an ongoing online meeting, the third request comprising fourth location information associated with the third device; and
the processor is further configured to:
determine whether to allow the third device to join the online meeting comprising the first device and the second device based on the third location information, the fourth location information, third time information associated with the third request, and fourth time information associated with the fourth request.

7. The system of claim 6, wherein the processor configured to determine whether to allow the third device to join the online meeting is further configured to:
determine, using the third location information and the fourth location information, whether the first device is located within a pre-determined distance from the third device; and
determine, using the third time information and the fourth time information, whether the third request was received within a pre-determined amount of time from the fourth request.

8. A method, comprising:
receiving a first request from a first device to initiate an online meeting, the first request comprising first location information associated with the first device;
receiving a second request from a second device to initiate an online meeting, the second request comprising second location information associated with the second device; and
determining whether to initiate an online meeting comprising the first device and the second device based on the first location information, the second location information, first time information associated with the first request, and second time information associated with the second request.

9. The method of claim 8, wherein determining whether to initiate the online meeting further comprises determining, using the first location information and the second location information, whether the first device is located within a pre-determined distance from the second device.

10. The method of claim 8, wherein determining whether to initiate the online meeting further comprises determining, using the first time information and the second time information, whether the first request was received within a pre-determined amount of time from the second request.

11. The method of claim 8, wherein the first location information is determined based on wireless data signals associated with the first device.

12. The method of claim 8, wherein the first time information is determined based on a time at which the first request was received.

13. The method of claim 8, further comprising:
receiving a third request from the first device to allow another device to join the online meeting, the third request comprising third location information associated with the first device;
receiving a fourth request from a third device to join an ongoing online meeting, the third request comprising fourth location information associated with the third device; and
determining whether to allow the third device to join the online meeting comprising the first device and the second device based on the third location information, the fourth location information, third time information associated with the third request, and fourth time information associated with the fourth request.

14. The method of claim 13, wherein determining whether to allow the third device to join the online meeting further comprises:
determining, using the third location information and the fourth location information, whether the first device is located within a pre-determined distance from the third device; and
determining, using the third time information and the fourth time information, whether the third request was received within a pre-determined amount of time from the fourth request.

15. A computer readable medium comprising instructions configured, when executed by a processor, to:
receive a first request from a first device to initiate an online meeting, the first request comprising first location information associated with the first device;
receive a second request from a second device to initiate an online meeting, the second request comprising second location information associated with the second device; and
determine whether to initiate an online meeting comprising the first device and the second device based on the first location information, the second location information, first time information associated with the first request, and second time information associated with the second request.

16. The computer readable medium of claim 15, wherein the instructions configured, when executed by the processor, to determine whether to initiate the online meeting are further configured, when executed by the processor, to determine, using the first location information and the second location information, whether the first device is located within a pre-determined distance from the second device.

17. The computer readable medium of claim 15, wherein the instructions configured, when executed by the processor, to determine whether to initiate the online meeting are further configured, when executed by the processor, to determine, using the first time information and the second time information, whether the first request was received within a pre-determined amount of time from the second request.

18. The computer readable medium of claim 15, wherein the first location information is determined based on wireless data signals associated with the first device.

19. The computer readable medium of claim 15, wherein the instructions are further configured, when executed by the processor, to:
receive a third request from the first device to allow another device to join the online meeting, the third request comprising third location information associated with the first device;
receive a fourth request from a third device to join an ongoing online meeting, the third request comprising fourth location information associated with the third device; and
determine whether to allow the third device to join the online meeting comprising the first device and the second device based on the third location information, the fourth location information, third time information associated with the third request, and fourth time information associated with the fourth request.

20. The computer readable medium of claim 19, wherein the instructions configured, when executed by the processor, to determine whether to allow the third device to join the online meeting are further configured, when executed by the processor, to:
determine, using the third location information and the fourth location information, whether the first device is located within a pre-determined distance from the third device; and
determine, using the third time information and the fourth time information, whether the third request was received within a pre-determined amount of time from the fourth request.
